(19) United States
(12) Patent Application Publication
(10) Pub. No.: US 2024/0408990 A1
(43) Pub. Date: Dec. 12, 2024

(54) CHARGER VOLTAGE DROP COMPENSATION

(71) Applicant: Rivian IP Holdings, LLC, Irvine, CA (US)

(72) Inventors: Aashiv Vij, Los Alamito, CA (US); Steven Schulz, Torrance, CA (US)

(21) Appl. No.: 18/330,825

(22) Filed: Jun. 7, 2023

(51) Int. Cl. B60L 53/62; H02J 1/02; H02J 3/01; H02J 3/16; H02J 7/00

(52) U.S. Cl. CPC B60L 53/62; H02J 1/02; H02J 3/01; H02J 3/16; H02J 7/00712

(57) ABSTRACT

A system can include a controller. The controller can receive a signal from a charger that indicates a voltage drop in a voltage received by the charger from a power supply. The controller can operate the power supply to increase the voltage output by the power supply responsive to the signal that indicates the voltage drop.

### INTRODUCTION

A vehicle, such as an electric vehicle, can be powered by batteries. The batteries can be charged by a charger.

### SUMMARY

The present solution is generally directed to a system for charger voltage drop compensation. A charger can include a voltage sensor that detects a voltage drop in a voltage provided by a power supply of a power system. The charger can transmit a signal to a controller of the power system indicating a voltage drop based on measurements of the sensor. The controller of the power system can determine, based on the signal received from the charger, to increase or boost the voltage that the power supply provides to the charger. The controller can operate a boost module of the power supply to increase the voltage output by the power source to compensate for the voltage drop. With this voltage drop compensation, a charger installation can have an increased level of reliability. Furthermore, the power source and the charger can be located an increased distance apart without a voltage drop between the power source and the charger creating operational issues for the charger. The voltage compensation can create lower cost and more reliable charger installations in commercial fleet applications or residential installations. The charger installations can be lower cost because the charger installations can utilize higher gauge wires (e.g., thinner wires). The installations can be performed faster and with less expense because installation technicians may not need to be concerned with the distance between the power source and the charger.

At least one aspect is directed to a system. The system can include a controller. The controller can receive a signal from a charger that indicates a voltage drop in a voltage received by the charger from a power supply. The controller can operate the power supply to increase the voltage output by the power supply responsive to the signal that indicates the voltage drop.

At least one aspect is directed to a method. The method can include receiving, by a controller, a signal from a charger that indicates a voltage drop in a voltage received by the charger from a power supply. The method can include operating, by the controller, the power supply to increase the voltage output by the power supply responsive to the signal that indicates the voltage drop.

At least one aspect is directed to a system. The system can include a controller. The controller can detect a voltage drop in a voltage received by a charger from a power supply. The controller can transmit a signal to cause the power supply to increase the voltage output by the power supply responsive to a detection of the voltage drop.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system to charge a vehicle with voltage drop compensation.

FIG. 2 depicts an example system to charge a fleet of vehicles with voltage drop compensation.

FIG. 3 depicts an example electric vehicle that charges with a charger.

FIG. 4 depicts an example method of a power system compensating for voltage drop.

FIG. 5 depicts an example method of a charger detecting and compensating for a voltage drop.

FIG. 6 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems for charger voltage drop compensation. The various concepts introduced above and discussed in greater detail below may be implemented in any of numerous ways.

A power source, such as an Automatic Grid Disconnect (AGD), can provide power to a charger that charges a battery, battery module, or battery pack, such as that provided on a vehicle, such as an electric, hybrid, or combustion engine vehicle. The charger can be a uni-directional or bi-directional charger. The charger can be a direct current (DC) fast charger. The power source can provide a high voltage or a low voltage to the charger (e.g., a first voltage or a second voltage). The low voltage can be 12 volts, 24 volts, or 30 volts. The low voltage can be provided by the power source continuously. For example, in a fleet charging infrastructure, a power cabinet may continuously provide the low voltage to dispensers that charge vehicles. The power source can include a battery back-up. The power source can provide the low voltage to the charger via the battery back-up responsive to a power grid being unavailable to provide power. A charger or dispenser can include low voltage components that are powered by the low voltage, for example, the charger can include microcontrollers, display screens, communication circuits, or charging components.

The low voltage provided by the power source to the charger drops over the cable (e.g., wire) between the power source and the charger due to the resistance of the wires or cables. The longer the length of the cable (e.g., the larger the distance between the power source and the charger), the more significant the drop in voltage over the length of the cable. Therefore, conventionally, the length of the cable may limit the distance between the power source and the charger to below a threshold, e.g., 80 to 83 feet, 79 to 84 feet, less than 79 feet, more than 84 feet. In the examples in which the power source and the charger are installed in a building, facility, or other infrastructure where the distance between the power source and the charger is greater than the threshold, the significant drop in voltage can reduce the performance of the low-voltage components of the charger or prevent the low voltage components of the charger from operating.

Because the thickness of a wire and the resistance of the wire are inversely proportional, some conventional implementations increase the thickness (e.g., decrease the gauge) of wires between the power source and the charger to decrease the resistance of the wire and thus decrease the voltage drop between the power source and the charger. However, increasing the thickness of the wires results in increased cost, increased materials, and increased cable weight.

To address technical problems including those mentioned above, the present solution can include a voltage sensor that detects a voltage drop and a boost module that boosts the voltage responsive to the voltage drop to compensate for the voltage drop. For example, the charger or dispenser of a charging system can include the voltage sensor. The voltage sensor can include an analog circuit or a digital circuit that generates an analog or digital signal indicating a voltage level received from the power source. The signal can indicate an amount of voltage drop over the wires between the power source and the charger. The charger or dispenser can transmit the signal to the power source. The signal can indicate the voltage drop. For example, the charger or dispenser can provide a feedback signal via a controller area network (CAN) bus, an Ethernet network, a Wi-Fi network, a Zigbee network, a serial peripheral interface (SPI) bus, or a universal asynchronous receiver-transmitter (UART) bus, or any other communications bus or medium.

The power source can include at least one controller, microcontroller, digital circuit, or analog circuit that can determine, based on the signal received from the charger or dispenser, to increase or boost the voltage that the power source provides to the charger or dispenser. Furthermore, the controller of the power source can determine a level to boost the voltage signal by. The power source can use the level to operate a boost module of the power source to increase the voltage provided by the power source to compensate for the voltage drop. The boost module can reduce a current across the cable to compensate for the voltage drop across the cable.

With this voltage drop compensation, a charger installation can have an increased level of reliability. Furthermore, the power source and the charger can be located an increased distance apart without a voltage drop between the power source and the charger creating operational issues for the charger. The voltage compensation can create lower cost and more reliable charger installations in commercial fleet applications or residential installations. The charger installations can be lower cost because the charger installations can utilize higher gauge wires (e.g., thinner wires). The installations can be performed faster and with less expense because installation technicians may not need to be concerned with the distance between the power source and the charger.

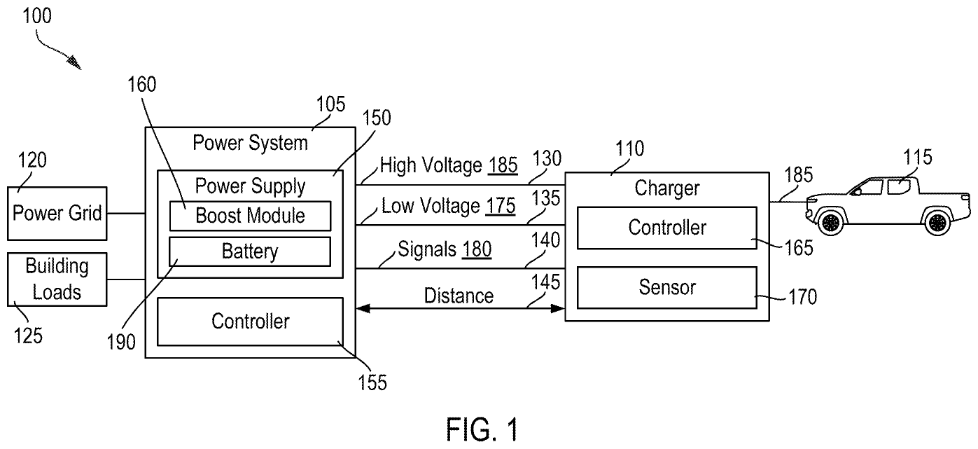

Referring now to FIG. 1, among others, an example system 100 to charge a vehicle 115 that can implement voltage drop compensation is shown. The system 100 can include at least one power system 105. The power system 105 can be a system, apparatus, device, box, or component. The power system 105 can interface, connect, or couple with a power source such as at least one power grid 120. The power system 105 can be coupled with the power grid 120 via an interface such as a plug, a cable, wire, switch, or fuse box. In other words, the power system 105 can receive power from the power grid 120. The power system 105 can provide the power to a charger 110 to charge a vehicle 115. Furthermore, the power system 105 can receive power from solar panels of a building, a wind turbine, or a water turbine and provide the received power to the charger 110 to charge the vehicle 115.

The power system 105 can include at least one power supply 150. The power supply 150 can include circuits or components such as circuits, switches, regulators, filters, inverters, transformers, sensors, or rectifiers. The power supply 150 can provide power to the charger 110 to charge the vehicle 115. The power supply 150 can receive power from the power grid 120 and provide the power to the charger 110 to charge the vehicle 115. For example, the power supply 150 can receive alternating current (AC) power from the power grid 120. The power received from the power grid 120 can be at 110 to 120 volts AC. The power received from the power grid 120 can be at 220 to 240 volts AC. The power received from the power grid 120 can be at 60 hertz (Hz), 50 Hz, 40 Hz or any other frequency.

The power supply 150 can provide a high voltage 185 (e.g., a first voltage) to the charger 110. The power supply 150 can provide the high voltage 185 to the charger 110 over at least one conductor, wire, or cable 130. At least one wire of the cable 130 can be a positive wire of the high voltage 185. At least one wire of the cable 130 can be a negative voltage, ground, or neutral wire for the high voltage 185. The cable 130 can include wires for multiple phases of an AC signal. The power supply 150 can output the high voltage 185 to the cable 130 to provide power to the charger 110. For example, the power supply 150 can provide AC power to the charger 110 via the cable 130. For example, the power supply 150 can reduce a voltage level of the AC power and provided the reduced voltage level to the charger 110 via the cable 130. The high voltage 185 can be a DC voltage. In this regard, the power supply 150 can convert the AC power into DC power and provide the DC power to the charger 110 via the cable 130.

Furthermore, the power supply 150 can provide a low voltage or second voltage 175 to the charger 110. The power supply 150 can output the low voltage 175 to the charger 110. For example, the power supply 150 can output the low voltage 175 on at least one wire, conductor, or cable 135. The low voltage 175 can be a DC voltage or an AC voltage. For example, the low voltage 175 can be a voltage of the battery 190. For example, the battery 190 can discharge to provide current to the charger 110 over the cable 135 such that the low voltage 175 is provided to the charger 110. The battery 190 can discharge to output the low voltage 175 to the charger 110 responsive to a determination that the voltage of the power grid 120 is less than a level. The low voltage 175 can be twelve volts DC. The low voltage 175 can be twenty-four volts DC. The low voltage 175 can be 30 volts DC. The low voltage 175 can be a voltage between ten and twenty-five volts. The low voltage 175 can be a voltage between five and thirty volts. The low voltage 175 can be less than five volts. The low voltage 175 can be greater than thirty volts.

The power supply 150 can provide the high voltage 185 to the charger 110 based on power received from the power grid 120. However, responsive to the power grid 120 being down, the power grid 120 being turned off, the power grid 120 being disconnected, the power grid 120 entering a fault state, the power grid 120 providing a voltage to the power supply 150 that is less than a level, the power grid 120 providing a current to the power supply 150 that is less than a level, or the power grid 120 providing a current to the power supply 150 that is greater than a level, the power supply 150 can cause the battery 190 to provide power to the charger 110. For example, the power system 105, the power supply 150, or the controller 155 can cause the battery 190 to be switched via a switch or contactor of the power supply 150 to couple with the cable 135 to provide the low voltage 175 to the charger 110 and cause the battery 190 to discharge. The power system 105 or a fuse box can include one or multiple fuses or disconnects that couple with the power grid 120 and disconnect the power system 105 or the power supply 150 from the power grid 120 responsive to a current provided by the power grid 120 exceeding a level. Responsive to a fuse or disconnect tripping, triggering, or disconnecting the power system 105 from the power grid 120, the power system 105, the power supply 150, or the controller 155 can cause the battery 190 to provide the lower voltage 175 to the charger 110.

The power supply 150 can include at least one battery 190. The battery 190 can be a battery, battery pack, battery module, or a group or set of batteries. The battery 190 can be or include lithium-ion batteries that include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer. The battery 190 can include lithium-ion batteries that can include a graphite chemistry, a silicon-graphite chemistry, or a lithium metal chemistry for the anode layer).

The battery 190 can charge based on power received from the power grid 120. Furthermore, the battery 190 can charge based on power received from the charger 110 and the vehicle 115 via the cable 130 or the cable 135. Furthermore, the power system 105 can use power received from the charger 110 and the vehicle 115 to power the building loads 125. In this regard. the system 100 can be a bi-directional charging system. The power system 105 can provide power received from the power grid 120 to the building loads 125 (e.g., building heating, ventilation, or air conditioning systems, lights, power outlets, appliances, computers, smartphones). The power supply 150 can operate the battery 190 to provide power to the building loads 125 responsive to the power grid 120 being unavailable to provide power. The power system 105 can operate the battery 190 to provide power to the charger 110 to charge the vehicle 115 responsive to the power grid 120 being unavailable.

The power supply 150 can include at least one boost module 160. The boost module 160 can be a device, apparatus, system, or circuit. For example, the boost module 160 can be a boost converter that operates to step up, increase, boost, or raise the low voltage 175 from a first level to a second level. The boost converter can include a joule thief, a buck-boost converter, a split-pi topology converter, etc. The boost module 160 can be an analog circuit including multiple electrical components such as filters, switches, transistors, resistors, capacitors, etc. The boost module 160 can be operated or controlled by the controller 155 to increase or boost the low voltage 175. The boost module 160 can increase the low voltage 175 and decrease a current provided to the charger 110 over the cable 135. For example, the boost module 160 can operate to decrease a current output by the power supply 150 over the cable 135 while increasing a voltage output by the power supply 150 to the charger 110 over the cable 135. The boost module 160 can boost a voltage provided by the battery 190.

The power system 105 can include at least one controller 155. The controller 155 can include at least one analog circuit, digital circuit, or analog-digital circuit. The controller 155 can be a microprocessor, microcontroller, processor, data processing system, or computing system. The controller 155 can operate or control the power system 105, the power supply 150, or the boost module 160 to increase, raise, or boost the low voltage 175 from a first level to a second level. The controller 155 can operate the power system 105, the power supply 150, or the boost module 160 responsive to a signal 180. The controller 155 can be electrically coupled with a communication medium, channel, or bus 140.

For example, the communication medium 140 can be a cable, wire, network infrastructure, wireless network, or other communication medium. The controller 155 and a controller 165 of the charger 110 can communicate via the bus 140 via a CAN protocol, a SPI protocol, an inter-integrated circuit (I2C) protocol, a UART protocol, a universal synchronous asynchronous receiver transmitter (USART) protocol, a local area (LAN), a user datagram protocol (UDP), a transmission control protocol (TCP) protocol, an MQ telemetry transport (MQTT) protocol or any other communication or network protocol. The controller 155 and the controller 165 can include communication modules, such as wired communication modules, wireless communication modules, or radios that can transmit or receive signals over a wired or wireless medium 140. The controller 155 and the controller 165 can communicate via a Wi-Fi network, a Zigbee network, a Bluetooth network, or any other wireless network.

The controller 155 can operate or control the boost module 160 to compensate for a voltage drop between the power system 105 and the charger 110. The boost module 160 can boost the voltage of the battery 190 to increase the low voltage 175 output by the power supply 150. The boost module 160 can boost the voltage of the battery 190 responsive to the signal 180 that indicates the voltage drop. For example, the controller 155 can operate the boost module 160 to increase, boost, or raise the low voltage 175 output by the power supply 150. The controller 155 can operate the boost module 160 to increase the low voltage 175 such that the low voltage 175 received by the charger 110 is at a level above a threshold or within a range of voltages. The threshold can be a level needed for the charger 110 to operate or charge the vehicle 115 based on the low voltage 175. Without the boost module 160 boosting the low voltage 175, the low voltage 175 output by the power supply 150 can be a first level. The controller 155 can operate the boost module 160 to increase the low voltage 175 output by the power supply 150 to a second level greater than the first level. The controller 155 can operate the boost module 160 to increase the low voltage 175 output by the power supply 150 to the second level such that the low voltage 175 received by the charger 110 is at the first level in view of the voltage drop across the cable 135.

The controller 155 can receive data, data packets, messages, information, or signals 180 over the communication bus 140. For example, the controller 155 can receive signals 180 over the communication bus 140 from the charger 110 or a controller 165 of the charger 110. The controller 155 can be a first controller while the controller 165 can be a second controller. Alternatively, the controller 155 can be a second controller while the controller 165 can be a first controller. The signals 180 can be voltage signals, current signals, electro-magnetic signals, bits, bytes, bit patterns, signal amplitude, phase information, etc. The controller 155 can determine, based on a signal 180, to operate the boost module 160 to increase the low voltage 175 to compensate for a voltage drop across the cable 135. For example, the signals 180 can include a measurement of a sensor 170 of the low voltage 175. The signals 180 can indicate a voltage level of the low voltage 175 received at the charger 110. The signals 180 can indicate an amount or level to increase the low voltage 175 by. The signals can indicate a voltage drop in the low voltage 175 received at or by the charger 110 from the power supply 150. The signals 180 can indicate a difference in voltage of the low voltage 175 between an expected voltage and a voltage measured by the sensor 170. Responsive to the signal 180, the controller 155 can operate the boost module 160 to increase the low voltage 175.

The charger 110 can include at least one sensor 170. The sensor 170 can be a voltage sensor that measures, determines, sense, or detects a level of the low voltage 175. The sensor 170 can measure the low voltage 175 received at the charger 110. The sensor 170 can be a voltage meter such as a capacitive type voltage sensor or a resistive type voltage sensor. The sensor 170 can be any voltage meter, device, or apparatus that can measure voltage used in electric vehicle chargers. For example, the sensor 170 can measure the low voltage 175 received at one or more input connections of the charger 110. The sensor 170 can be electrically or magnetically coupled with the cable 135 to measure the low voltage 175 received at the charger 110. The sensor 170 can generate a signal, a voltage, a current, or adjust a resistance value to indicate the low voltage 175. The signal can be based on the measured low voltage 175. The sensor 170 can provide the signal to a controller 165 of the charger 110. The sensor 170 can be an active or passive electronic component, circuit, or device. The controller 165 can communicate with the sensor 170 to read a voltage measurement of the sensor 170. The sensor 170 can measure the low voltage 175 received by the charger 110.

The charger 110 can include at least one controller 165. The controller 165 can determine, detect, sense, or identify a voltage drop in the low voltage 175 received from the power supply 150. The controller 165 of the charger 110 can be electrically coupled with the sensor 170. The controller 165 can receive measurements, signals, data, or other information from the sensor 170 that indicates the low voltage 175. The controller 165 can determine that the signal received from the sensor 170 indicates a voltage drop in the low voltage 175. The controller 165 can detect, based on a signal received from the sensor 170, an amount of voltage drop across the cable 135. The controller 165 can determine, based on the signal or the determined amount of voltage drop across the cable 135, whether to increase the low voltage 175 or an amount by which to increase the low voltage 175.

The controller 165 can be coupled with the communication bus 140. The controller 165 can transmit a request, command, message, or signal 180 to the controller 155 via the communication medium 140. The signal 180 can include a request to increase the low voltage 175, a request to increase the low voltage 175 by a particular amount, a request to increase the low voltage 175 to a particular level. The controller 165 can cause the power supply 150 to increase the low voltage 175 to compensate for the voltage drop across the cable 135 by transmitting the signal 180 to the power system 105 or the controller 155. The controller 165 can transmit the signal 180 to cause the power supply 150 to increase the low voltage 175 output by the power supply 150 responsive to a detection or determination of the voltage drop by the controller 165. The controller 165 can transmit the signal 180 to the controller 155 responsive to a reception of the second signal from the sensor 170.

The charger 110 can provide power to the vehicle 115 via a wire, harness, or cable 185. The charger 110 can provide power to the vehicle 115 via the high voltage 185 or the low voltage 175. The charger 110 can provide power to the vehicle 115 to charge a battery, battery pack, battery module, or battery cell of the vehicle 115. The charger 110 can receive power from the battery, battery pack, battery module, or battery cell of the vehicle 115 and provide the power to the power system 105 to charge the battery 190 or power the building loads 125.

The power system 105 and the charger 110 can be separated by a distance 145. The distance 145 can be fifty to 100 feet. The distance 145 can be up to 500 feet or more. In view of at least one of the distance or gauge of the wires of the cable 135, the low voltage 175 can drop from an output of the power supply 150 to an input at the charger 110. The thinner the wires of the cable 135 and the longer the wires of the cable 135, the greater the voltage drop across the cable 135. The length and gauge of the wires of the cable 135 can cause the low voltage 175 provided by the power supply 150 over the cable 135 to drop from a first level at an output of the power supply 150 to a second level at an input to the charger 110. The controller 155, based on the signals 180 received from the controller 165, can operate the power supply 150 to increase the low voltage 175 output by the power supply 150. The controller 155 can operate the power supply 150 to output the low voltage 175 at an increased level such that the low voltage 175 received at the charger 110 is the first voltage, or approximately equal to the first voltage (e.g., within a tolerance or deviation from the first voltage).

The controller 155 and the controller 165 can operate together to control the low voltage 175 such that the level of the low voltage 175 received at the charger 110 is at a level or within a threshold or deviation from the level. For example, the controller 155 can implement a control algorithm such as a proportional algorithm, a proportional integral algorithm, a proportional integral derivative algorithm. The controller 165 can transmit feedback information measured by the sensor 170 via the signals 180. The controller 155 can utilize the feedback information as an input into the algorithm run by the controller 155. The controller 155 can identify to boost the voltage, increase the boost of the voltage, decrease the boost of the voltage, or lower the voltage. The controller 155 operate the boost module 160 to increase the low voltage 175 or decrease the low voltage 175. The controller 155 can continuously execute the control algorithm, execute the control algorithm until the low voltage 175 received at the charger 110 is at a predefined level or within a predefined range, or execute the control algorithm responsive to a signal 180 indicating that the low voltage 175 received at the charger 110 is outside a particular range of voltages. The controller 155 can execute the control algorithm responsive to the power system 105 or the charger 110 being installed, powered on, or coupled with the vehicle 115.

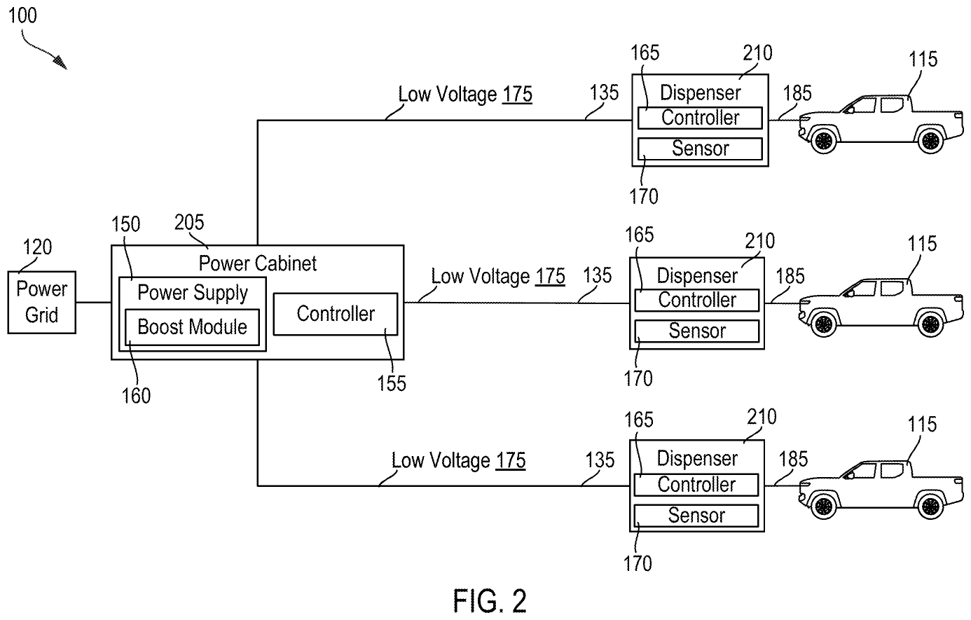

Referring now to FIG. 2, among others, an example system 100 to charge a fleet of vehicles 115 where the system 100 includes voltage drop compensation is shown. The system 100 can include a power cabinet 205. The power cabinet 205 can be powered via the power grid 120. The power cabinet 205 can provide power to at least one dispenser 210. The system 100 can include one or multiple dispensers 210 that can be electrically coupled, connected, linked, or attached to the power cabinet 205 or the power supply 150. The dispensers 210 can be coupled with the power cabinet 205 via cables 135. For example, the power cabinet 205 can provide a low voltage 175 to dispensers 210 over cables 135. For example, the dispensers 210 can receive the low voltage 175 over the cables 135 from the power supply 150.

For example, a power supply 150 of the power cabinet 205 can provide a first low voltage 175 to a first dispenser 210 via a first cable 135. The power supply 150 of the power cabinet 205 can provide a second low voltage 175 to a second dispenser 210 via a second cable 135. The power supply 150 of the power cabinet 205 can provide a third low voltage 175 to a third dispenser 210 via a third cable 135. The power supply 150 of the power cabinet 205 can provide a low voltage 175 over a cable 135 to any number of dispensers 210 to charge any number of vehicles 115.

The dispensers 210 can include sensors 170 that can measure, sense, detect, or determine the low voltage 175 received from the power supply 150. For example, if the sensor 170 of one of the dispensers 210 detects that the low voltage 175 has dropped by at least a particular amount, the controller 165 of the dispenser 210 can transmit a signal 180 to the power cabinet 205 or the controller 155. The signal 180 can indicate that the voltage received by the dispenser 210 from the power supply 150 is less than a level. Responsive to receiving the signal 180, the controller 155 can operate the power supply 150 to increase the low voltage 175 output by the power supply 150 or the power cabinet 205 to the dispenser 210. For example, the controller 155 can operate the boost module 160 of the power supply 150 to boost the low voltage 175 provided to the particular dispenser 210 that experienced the voltage drop. The controller 155 can operate the power supply 150 or the boost module 160 to increase, boost, or raise the low voltage 175 output to each individual dispenser 210. The controller 155 may not increase, boost, or raise a low voltage 175 provided to one of the dispensers 210 while increasing, boosting, or raising the low voltage 175 provided to another dispenser 210. For example, the controller 155 can increase a first low voltage 175 provided to the first dispenser 210 by a first amount, increase a second low voltage 175 provided to the second dispenser 210 by a second amount, and not increase a third low voltage 175 provided to a third dispenser 210. In this regard, the power cabinet 205, the controller 155, or the power supply 150 can individually control the low voltage 175 provided to each of the dispensers 210 or at least some of the dispensers 210. This individualized control can compensate for voltage drop when the dispensers 210 are all separated by a different distance to the power cabinet 205 or are coupled with the power cabinet 205 via different gauge wires or cables.

In comparison to the power system 105 of FIG. 1, which may provide the low voltage 175 to the charger 110 as back-up power responsive to the power grid 120 becoming unavailable as a back-up, the power cabinet 205 can continuously or regularly provide the low voltage 175 to the dispensers 210 based on the power received form the power grid 120 to charge the vehicles 115. For example, the power supply 150 of the power cabinet 205 can convert AC power received from the power grid 120 to a DC voltage 175, and provide the DC voltage 175 to each of the dispensers 210 as the main or only voltage used to charge the vehicles 115.

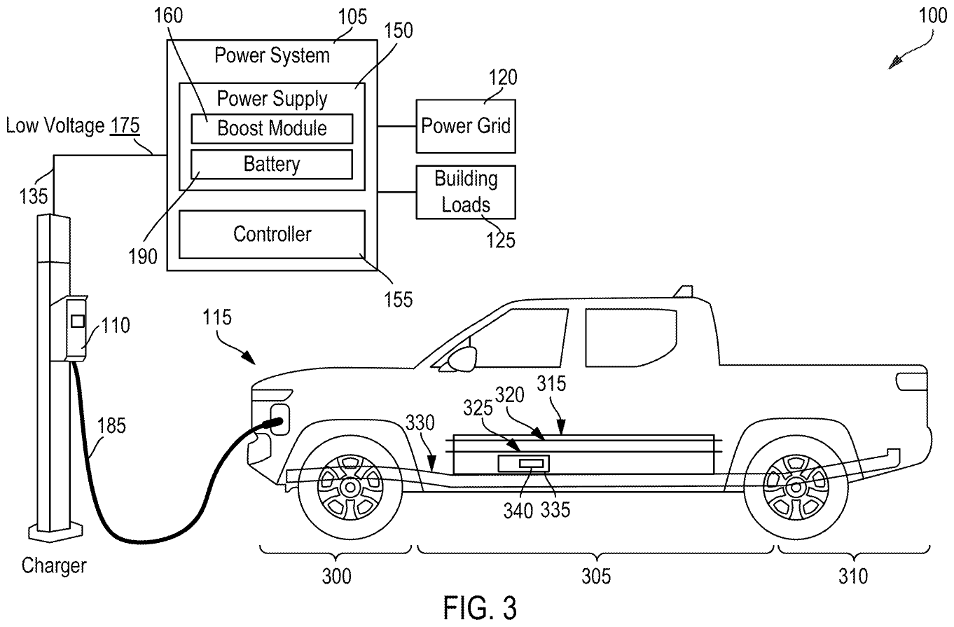

Referring now to FIG. 3, among others, an example electric vehicle 115 that charges with the charger 110 is shown. The electric vehicle 115 can charge via the charger 110 and the cable 110. The charger 110 can receive power from the power system 105 and provide the power to the vehicle 115 to charge a battery pack 315 of the vehicle 115. For example, the charger 110 can charge a battery 315 of the vehicle 115 based on the low voltage 175 output by the power supply 150. Furthermore, the vehicle 115 can discharge the battery pack 315 to provide power to the charger 110, which the charger 110 can provide to the power system 105. The power system 105 can provide the power to the building loads 125 or charge the battery 190 of the power supply 150.

At least one battery pack 315 can be installed with the vehicle 115. Electric vehicles 115 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 315 can also be used as an energy storage system to power a building, such as a residential home or commercial building, e.g., the building loads 125. Electric vehicles 115 can be fully electric or partially electric (e.g., plug-in hybrid) and further, electric vehicles 115 can be fully autonomous, partially autonomous, or unmanned. Electric vehicles 115 can also be human operated or non-autonomous. Electric vehicles 115, such as electric trucks or automobiles, can include on-board battery packs 315, batteries 335 or battery modules 335, or battery cells 340 to power the electric vehicles 115. The electric vehicle 115 can include a chassis 330 (e.g., a frame, internal frame, or support structure). The chassis 330 can support various components of the electric vehicle 115. The chassis 330 can span a front portion 300 (e.g., a hood or bonnet portion), a body portion 305, and a rear portion 310 (e.g., a trunk, payload, or boot portion) of the electric vehicle 115. The battery pack 315 can be installed or placed within the electric vehicle 115. For example, the battery pack 315 can be installed on the chassis 330 of the electric vehicle 115 within one or more of the front portion 300, the body portion 305, or the rear portion 310. The battery pack 315 can include or connect with at least one busbar, e.g., a current collector element. For example, the first busbar 320 and the second busbar 325 can include electrically conductive material to connect or otherwise electrically couple the battery 315, the battery modules 335, or the battery cells 340 with other electrical components of the electric vehicle 115 to provide electrical power to various systems or components of the electric vehicle 115.

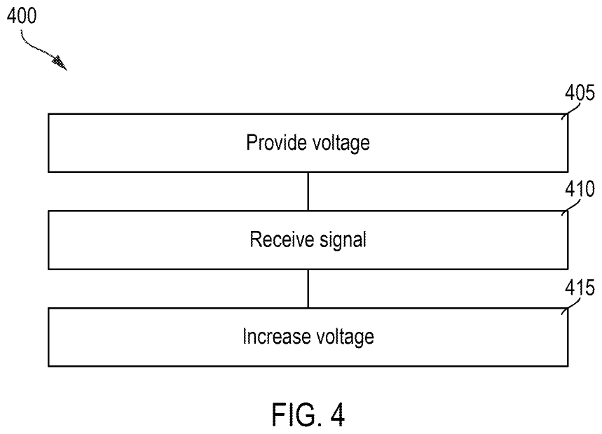

Referring now to FIG. 4, among others, an example method 400 of a power system compensating for voltage drop is shown. At least a portion of one ACT, step, or action of the method 400 can be performed by the power system 105, the power supply 150, the boost module 160, the battery 190, or the controller 155. Furthermore, at least a portion of the method 400 can be performed by a manufacturing system or apparatus, a manufacturing technician, or a robotic assembly device. The method 400 can include an ACT 405 of providing a voltage. The method 400 can include an ACT 410 of receiving a signal. The method 400 can include an ACT 415 of increasing a voltage.

At ACT 405, the method 400 can include providing a voltage. The method 400 can include providing the low voltage 175. The method 400 can include providing, by the power supply 150, the low voltage 175 to the charger 110 over the cable 135. However, the low voltage 175 can decrease or drop over the cable 135. The low voltage 175 can decrease based on a length of the cable 135 or a gauge of the cable 135. In this regard, the low voltage 175 output by the power supply 150 can be at a first level and the low voltage 175 received by the charger 110 can be at a second level less than the first level. The method 400 can include providing the low voltage 175 from the power supply 150 to the charger 110 as a back-up voltage source responsive to a power grid 120 being unavailable to provide power to the power system 105. For example, responsive to a detection that the power grid 120 is unavailable or a voltage level of the power grid 120 falling below a level, the power system 105 can provide the low voltage 175 to the charger 110. For example, providing the low voltage 175 to the charger 110 can include discharging a battery 190 of the power system 105. The power supply 150 can couple the battery 190 with the charger 110 or cause the battery 190 to discharge responsive to a detection that a voltage of the power grid 120 is less than a level. The power supply 150 can operate a contactor or switch to electrically couple the battery 190 with the cable 135 to cause the battery 190 to discharge. Coupling the battery 190 with the cable 135 can cause the battery to discharge and a current to flow across the cable 135 and a voltage of the battery 190 to be applied to the cable 135.

The method 400 can include providing the low voltage 175 from a power cabinet 205 to one or multiple dispensers 210 to charge vehicles 115. The power cabinet 205 can provide the low voltage 175 to the dispensers 210 based on power received from a power grid 120. The low voltage 175 can be the only voltage, or a main voltage, that the dispensers 210 use to charge vehicles 115.

At ACT 410, the method 400 can include receiving a signal. For example, the controller 155 can receive at least one signal 180 from the charger 110 or the controller 165. The signal 180 can indicate a voltage drop in the low voltage 175 received by the charger 110 from the power supply 150. The method 400 can include coupling the controller 155 with the communication bus 140. Coupling the controller 155 with the communication bus 140 can include electrically connecting attaching the controller 155 to at least one wire, cable, or device. The controller 155 can further couple with a wireless network by joining the network, registering with devices on the network, or signing in to the wireless network. The controller 155 can communicate with the controller 165 via the communication bus 140. The controller 155 and the controller 165 can communicate via any wired or wireless network, bus, or communication medium.

At ACT 415, the method 400 can include increasing a voltage. The ACT 415 can include increasing the voltage provided at ACT 405. The method 400 can include increasing. boosting, or raising the low voltage 175. The method 400 can including operating, by the controller 155, the power supply 150 to increase the low voltage 175 output by the power supply 150. The controller 155 can increase the low voltage 175 responsive to the signal 180. For example, the controller 155 can increase the low voltage 175 responsive to a reception of the signal 180 from the charger 110. The controller 155 can operate the power supply 150 to increase the low voltage 175 responsive the signal 180 indicating the voltage drop.

For example, the controller 155 can control or operate the power supply 150 by providing a signal, operating a switch, operating a contactor, adjusting a drive level, etc. of the power supply 150 or the boost module 160. The controller 155 can provide a signal to the power supply 150 to cause the power supply 150 to increase the low voltage 175 by a particular level. The controller 155 can operate the power supply 150 to increase the low voltage 175 by a set amount. Before the power supply 150 increase the voltage, the low volage 175 can be at a first level. The controller 155 can operate the power supply 150 to output the low voltage 175 at a second level greater than the first level. Because the low voltage 175 decreases over the cable 135, the power supply 150 can increase the low voltage 175 to a second level at the output of the power supply 150 such that the low voltage 175 received at the charger 110 can be at the first level.

The method 400 can include providing a boost module 160. The boost module 160 can increase the low voltage 175. For example, the boost module 160 can be operated by the controller 155 and increase the low voltage 175 from a first level to a second level to compensate for a voltage drop across the cable 135. The boost module 160 can be operated to cause the power supply 150 to output the low voltage 175 at an increased level. The boost module 160 can boost the low voltage 175 from the first level to the increased second level responsive to a reception of a signal from the controller 155. The boost module 160 can boost or increase the low voltage 175 responsive to the controller 165 transmitting the signal 180 to the controller 155 or the controller 155 receiving the signal 180 from the controller 165. The boost module 160 or the power supply 150 can boost the low voltage 175 provided to the charger 110 or the dispenser 210.

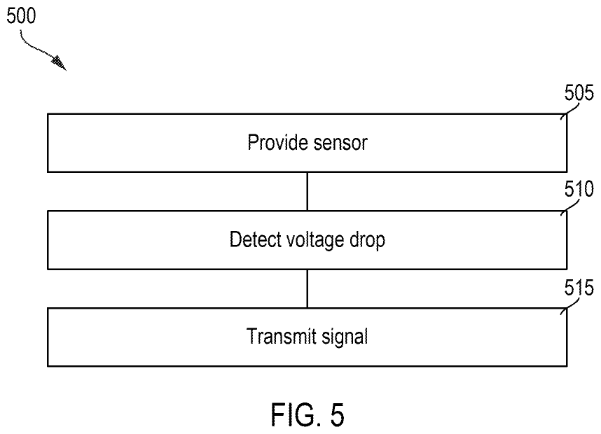

FIG. 5 depicts an example method of a charger detecting and compensating for a voltage drop. At least a portion of one ACT, step, or action of the method 500 can be performed by the charger 110, the controller 165, or the sensor 170. Furthermore, at least a portion of the method 500 can be performed by a manufacturing system or apparatus, a manufacturing technician, or a robotic assembly device. The method 500 can include an ACT 505 of providing a sensor. The method 500 can include an ACT 510 of detecting a voltage drop. The method 500 can include an ACT 515 of transmitting a signal.

At ACT 505, the method 500 can include providing a sensor 170. For example, the method 500 can include disposing the sensor 170 in the charger 110 or the dispenser 210. The ACT 505 of the method 500 can include coupling the sensor 170 with the controller 165, coupling the sensor 170 with the dispenser 210, or coupling the sensor 170 with the cable 135. The sensor 170 can be electrically coupled with the controller 165 such that the sensor 170 can provide signals to the controller 165 via the coupling or the controller 165 can read measurements of the sensors 170 via the coupling. The sensor 170 can be an active or passive electronic component, circuit, or device. The controller 165 can communicate with the sensor 170 to read a voltage measurement of the sensor 170. The sensor 170 can measure the low voltage 175 received by the charger 110.

At ACT 510, the method 500 can include detecting a voltage drop. The charger 110 can detect that a voltage level of the low voltage 175 is less than a level. The charger 110 can detect that a voltage level of the low voltage 175 received at the charger 110 is less than a level. The sensor 170 can measure the low voltage 175 at a connecting point, connector, or at an end of the cable 135. The sensor 170 can measure, determine, identify, sense, or detect the low voltage 175. The sensor 170 can provide a signal to the controller 165 that indicates the level of the low voltage 175 received at the charger 110. The controller 165 can determine, based on the signal received from the sensor 170, the level of the low voltage 175. The controller 165 can determine or detect the voltage drop in the voltage 175 received from the power supply 150. The controller can determine or detect that the low voltage 175 is less than a threshold. For example, the controller 165 can compare a measurement of the low voltage 175 received from the sensor 170 to a threshold. The controller 165 can compare the measurement of the low voltage 175 to a range of voltages and determine whether the low voltage 175 is outside of the voltage range. Responsive to determining that the measured low voltage 175 is less than the threshold or greater than the threshold, the controller 165 can generate the signal 180. The signal 180 can indicate that the low voltage 175 received at the charger 110 is greater than the threshold, that the low voltage 175 received at the charger 110 is less than the threshold, an amount that the low voltage 175 is greater than the threshold, or amount by which the low voltage 175 is less than the threshold.

At ACT 515, the method 500 can include transmitting a signal. The method 500 can include coupling the controller 165 with the communication bus 140. For example, the controller 165 can be coupled with the communication bus 140 such that the controller 165 can transmit or output signals 180 onto the communication bus 140. The controller 165 can transmit at least one signal 180 to the controller 155. The controller 165 can transmit the signals 180 to the controller 155 responsive to a detection of the voltage drop. The controller 165 can cause the power system 105 or the power supply 150 to boost or increase the low voltage 175 by transmitting the signals 180 to the power system 105 or the power supply 150 to increase the low voltage 175.

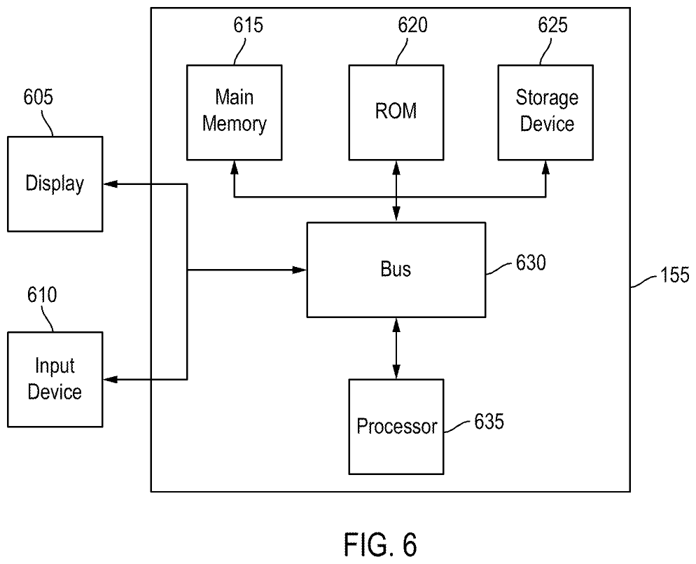

Referring now to FIG. 6, among others, an example controller 155 is shown. The computer system, computing device, computing apparatus, microcontroller, microprocessor, or controller of FIG. 6 can include or be used to implement a data processing system or its components. The system of FIG. 6 can be used to implement the controller 155, the controller 165, or any other computing device. The controller 155 includes at least one bus 630 or other communication component for communicating information and at least one processor 635 or processing circuit coupled to the bus 630 for processing information. The controller 155 can also include one or more processors 635 or processing circuits coupled to the bus for processing information. The controller 155 can also include at least one main memory 615, such as a random access memory (RAM) or other dynamic storage device, coupled to the bus 630 for storing information, and instructions to be executed by the processor 635. The main memory 615 can be used for storing information during execution of instructions by the processor 635. The controller 155 may further include at least one read only memory (ROM) 620 or other static storage device coupled to the bus 630 for storing static information and instructions for the processor 635. A storage device 625, such as a solid state device, magnetic disk or optical disk, can be coupled to the bus 630 to persistently store information and instructions.

The controller 155 may be coupled via the bus 630 to a display 605, such as a liquid crystal display, or active matrix display, for displaying information to a user such as a driver, user, or owner of the electric vehicle 115 or other end user. An input device 610, such as a keyboard or voice interface may be coupled to the bus 630 for communicating information and commands to the processor 635. The input device 610 can include a touch screen display 605. The input device 610 can also include a cursor control, such as a mouse, a trackball, or cursor direction keys, for communicating direction information and command selections to the processor 635 and for controlling cursor movement on the display 605.

The processes, systems and methods described herein can be implemented by the controller 155 in response to the processor 635 executing an arrangement of instructions contained in main memory 615. Such instructions can be read into main memory 615 from another computer-readable medium, such as the storage device 625. Execution of the arrangement of instructions contained in main memory 615 causes the controller 155 to perform the illustrative processes described herein. One or more processors in a multi-processing arrangement may also be employed to execute the instructions contained in main memory 615. Hard-wired circuitry can be used in place of or in combination with software instructions together with the systems and methods described herein. Systems and methods described herein are not limited to any specific combination of hardware circuitry and software.

Although an example computing system has been described in FIG. 6, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, the voltage drop compensation can be applied to DC charging systems, AC charging systems, uni-directional charging systems, bi-directional charging systems. The voltage drop compensation techniques can be applied to electric vehicle charging, electric bicycle charging, electric tricycle charging, electric skateboard charging, electric scooter charging, cell phone charging, power tool charging. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A system, comprising:
a controller to:
cause a battery disposed at a grid connection and comprising an output coupled to a boost module, to provide a voltage signal to a charger to charge an electric vehicle;
receive a signal from the charger that indicates a voltage drop in the voltage signal detected by the charger, wherein the voltage signal detected by the charger is at a voltage level less than a voltage level output by the battery; and
operate the boost module to increase the voltage level output by the battery to a second voltage level responsive to the signal that indicates the voltage drop.

2. The system of claim 1, comprising:
a power supply, comprising:
the boost module configured to boost the voltage level output by the battery to the second voltage level; and
the controller to operate the boost module to boost the voltage level output by the battery.

3. The system of claim 1, comprising:
the charger, comprising:
a second controller to:
detect the voltage drop in the voltage signal; and
transmit the signal to cause a power supply including the battery to increase the voltage level output by the battery responsive to a detection of the voltage drop.

4. The system of claim 1, comprising:
the controller, wherein the controller is coupled to a communication bus;
the charger comprising a second controller, the second controller to:
couple to the communication bus;
detect the voltage drop in the voltage signal; and
transmit the signal to the controller via the communication bus responsive to a detection of the voltage drop.

5. The system of claim 1, comprising:
the charger comprising:
a sensor to:
measure the voltage signal received from a power supply including the battery; and
provide a second signal to a second controller of the charger based on the measured voltage signal; and
the second controller to:
determine that the second signal indicates the voltage drop; and
transmit the signal to the controller responsive to a determination that the second signal indicates the voltage drop.

6. The system of claim 1, comprising:
a power supply comprising:
the battery to discharge responsive to a determination that a voltage of a power grid is less than a level; and
the boost module to boost the voltage level output by the battery to the second voltage level responsive to the signal that indicates the voltage drop.

7. The system of claim 1, comprising:
a plurality of dispensers coupled with a power supply, wherein a dispenser of the plurality of dispensers includes:
a sensor to detect the voltage signal received from the power supply; and
a second controller to transmit the signal to the controller, the signal indicates that the voltage signal received by the dispenser from the battery is less than a level; and
the controller to:
operate the power supply to increase the voltage level output by the battery.

8. The system of claim 1, comprising:
the charger to charge a battery of the electric vehicle based on the second voltage output by a power supply including the battery.

9. A method, comprising:
causing, by a controller, a battery disposed at a grid connection and comprising an output coupled to a boost module, to provide a voltage signal to a charger to charge an electric vehicle;
receiving, by the controller, a signal from the charger that indicates a voltage drop in the voltage signal detected by the charger, wherein the voltage signal detected by the charger is at a voltage level less than a voltage level output by the battery; and
operating, by the controller, the boost module to increase the voltage level output by the battery to a second voltage level responsive to the signal that indicates the voltage drop.

10. The method of claim 9, comprising:
providing, by the controller, a signal to cause the boost module of a power supply to increase the voltage level output by the battery; and
boosting, by the boost module, the voltage level output by the battery to the second voltage level responsive to the signal of the controller.

11. The method of claim 9, comprising:
detecting, by a second controller of the charger, the voltage drop in the voltage signal; and
transmitting, by the second controller, the signal to cause a power supply to increase the voltage level output by the battery responsive to a detection of the voltage drop.

12. The method of claim 9, comprising:
coupling the controller to a communication bus;
coupling a second controller of the charger to the communication bus;
detecting, by the second controller, the voltage drop in the voltage signal; and
transmitting, by the second controller, the signal to the controller via the communication bus responsive to a detection of the voltage drop.

13. The method of claim 9, comprising:
measuring, by a sensor of the charger, the voltage signal received from a power supply;
providing, by the sensor, a second signal to a second controller of the charger based on the measured voltage signal;
determining, by the second controller, that the second signal indicates the voltage drop; and
transmitting, by the second controller, the signal to the controller responsive to a determination that the second signal indicates the voltage drop.

14. The method of claim 9, comprising:
discharging, by the battery of a power supply, to output the voltage level to the charger responsive to a determination that a voltage of a power grid is less than a level; and
boosting, by the boost module of the power supply, the voltage level output by the battery to the second voltage level responsive to the signal that indicates the voltage drop.

15. The method of claim 9, comprising:
providing, by a power supply including the battery, the voltage signal to a plurality of dispensers;
detecting, by a sensor of a dispenser of the plurality of dispensers, a voltage received from the power supply;
transmitting, by a second controller of the charger, the signal to the controller indicating that the voltage the dispenser received from the power supply is less than a level; and
operating, by the controller, the power supply to increase the voltage level output by the battery to the dispenser.

16. A system, comprising:
a controller to:
detect a voltage drop in a voltage received by a charger from a battery of a power supply disposed at a grid connection; and
transmit a signal to cause the power supply to operate a boost module coupled with an output of the battery to increase a first voltage output by the battery to a second voltage responsive to a detection of the voltage drop.

17. The system of claim 16, comprising:
a sensor to:
measure the voltage received from the power supply; and
provide a second signal to the controller based on the measured voltage; and
the controller to transmit the signal to a second controller responsive to a reception of the second signal from the sensor, the second controller to operate the power supply to increase the first voltage output by the battery.

18. The system of claim 16, comprising:
the controller to:
couple to a communication bus;
detect the voltage drop; and
transmit the signal to a second controller via the communication bus responsive to the detection of the voltage drop.

19. The system of claim 16, comprising:
a component to charge a battery of an electric vehicle based on the second voltage output by the power supply.

20. The system of claim 16, comprising:
a plurality of dispensers coupled with the power supply to receive the voltage from the battery, wherein a dispenser of the plurality of dispensers includes:
a sensor to detect the voltage received from the battery; and
a second controller to transmit the signal to the power supply, the signal indicates that the voltage received by the dispenser from the power supply is less than a level.
